(19) United States
(12) Patent Application Publication
(10) Pub. No.: US 2001/0040986 A1
(43) Pub. Date: Nov. 15, 2001

(54) Memory aid

(75) Inventors: Jonathan Farringdon, Penshurst (GB); Leonard H. Poll, Redhill (GB); Armando S. Valdes, Orpington (GB)

Correspondence Address: Corporate Patent Counsel, U.S. Philips Corporation, 580 White Plains Road, Tarrytown, NY, 10591, US

(73) Assignee: KONINLIJKE PHILIPS ELECTRONICS N.V.

(21) Appl. No.: 09/854,380

(22) Filed: May 11, 2001

(30) Foreign Application Priority Data
May 12, 2000 (GB) 0011438.9

(51) Int. Cl. G06K 9/00

(52) U.S. Cl. 382/118

(57) ABSTRACT

A memory aid device is worn by a user to provide the user with memory cues. In a preferred arrangement the apparatus captures images of people that the user encounters. A face recognition process compares the face in the captured image with faces already held in storage means which have been captured previously. On establishing a face match, the previously captured image is displayed to the user on a display in the form of a wrist worn display, a head-up display or the like. The captured images have a field of view which is such that the backdrop and any foreground objects are also included. Aspects of the previously captured image such as a familiar backdrop, foreground objects or the fact that a person is wearing summer clothes all act as visual memory cues for the user to assist them in memory recall.

The present invention relates to a memory aid and more particularly to a memory aid for assisting a person with the task of recalling previous encounters with other people.

One known memory aid is a so-called “Remembrance Agent (RA), which has been developed by members of the media lab at MIT (Massachusetts Institute of Technology). The MIT remembrance agent is a computer based device which must be worn by the operator in order to function as a memory aid. The MIT RA consists of hardware including a computer, an input device in the form of a special keyboard permitting one-handed operation and a text based display. The text display is carried by an arrangement mounted on the wearers head such that the display hangs down a short distance in front of the user for viewing. For the RA to operate as a memory aid the wearer needs to be constantly typing information relating to their current activity. The typed information is checked for matches against information that has been entered previously and stored documents or other records with matching criteria are displayed. For the MIT RA to be of use, the user needs to enter information by the keyboard throughout the day while conducting various tasks. Such keyboard operation can be distracting to the user and considered socially unacceptable to the other people encountered. Operation is not autonomous.

According to one memory theory, the operation of the human memory can be divided into three components; encoding, storage and recall. Encoding refers to the loading of information into memory, which can then be stored. Recall involves retrieving desired information previously stored in memory. Remembering is considered as the collaborative product of information stored in the past and information present in the immediate cognitive environment of the subject person (Tulving E. & Thomson D. M. “Encoding specificity and retrieval processes in episodic memory” Psychological Review pp 352-373 Vol. 80(5), 1973). Loss of access to memory is what constitutes forgetting. Recall improves when cues that were present at the time of encoding are also present at the desired time of recall. For example, a student required to sit an examination will recall material more effectively during the examination if they revise the material in the examination hall rather than at home. A study of deep-sea divers suggested that there was indeed a context-dependency effect. Subjects who learnt in one environment and recalled in another recalled about 40% less than those subjects who learnt and recalled in the same environment.

Forgetting can be described as the inability to access or retrieve previously learnt information at the required time. People complain of having a bad memory when they forget names, faces, important dates such as birthdays or lose things. These are all obvious examples of forgetting.

Episodic memory is context-dependent, that is, it is only available in the context of specific contextual retrieval cues. In comparison, general knowledge (semantic memory) can be accessed in a variety of contexts. Memories of past events are organised into past episodes in which location of the episode, who was there, what was going on and what happened before or after, are all strong cues for recall. Physical context can be a very powerful cue.

The cognitive environment in which an event was perceived plays a role in the recollection process. Tulving uses the term ‘cognitive environment’ to refer to factors that influence encoding other than the events. Each event is encoded in a particular cognitive environment. Encoding is considered as a necessary condition for remembering even if a person is usually unaware of the encoding process. Encoding occurs when a perceived event is stored in memory and the product of encoding is the engram.

Retrieval can be a conscious process of recollection or a more automatic and involuntary retrieval process (this underlies much of our remembering). It has been proposed that there are likely to be different retrieval mechanisms for episodic and semantic memory. Typically we use the word “remember” for episodes and the word “know” for semantic memory.

For retrieval to occur, the system must be in “retrieval mode” and an appropriate retrieval cue must be present to set off the process.

The word “ecphory” is based on a Greek word, which means “to be made known”. Tulving described ecphory as a process in which the memory trace or the engram is combined with the retrieval cue to give a “conscious memory of certain aspects of the original event.”

The different stages of memory as proposed by Tulving are:

Original event—encoding—engram—retrieval—memory performance

To illustrate how this works, we cite an example used by Baddeley (Baddeley, A. (1997) Human Memory, Theory & Practice. Revised edition 1998 Allyn & Bacon, Massachusetts 1997). An event occurs and is encoded by the individual, which is a process involving an interaction between the event and the cognitive environment within that context. For example if an individual, while crossing a field, saw a horse, the cognitive environment would tell the individual that it was a horse and not a cow, possibly activate the word “horse”, linked to possible associated information on horses. This event and internal state would then be combined to produce a memory trace or engram.

Suppose the individual continued this walk and then met someone who asked whether they had seen a horse. This would act as a retrieval cue which would then interact with the memory trace of the encounter with the horse. This ecphoric information then leads to a response or to further recollective experiences.

Encoding according to Tulving, is the process that converts an event into an engram. Encoding is a necessary condition for remembering and always occurs when a perceived event is stored in memory. The engram is the product of encoding and a necessary prerequisite for the recollection of an event. Tens of thousands of them exist in a person's individual episodic memory and they become effective under special conditions known as retrieval. A cue will be specifically effective if it is specifically encoded at the time of learning. If the cue stimulus leads to the retrieval of the item then it is assumed to have been encoded, if not then it is assumed not to have been encoded.

Retrieval cues can be thought of as descriptions of descriptions. Tulving: “putting the two thoughts together, we end up with retrieval cue as the present description of a past description.” Tulving found in a series of experiments that subjects were able to recognise more than they could recall and the experimenter could use retrieval cues to enable the subject to access this information.

It is an object of the present invention to provide a memory aid that will provide a user with memory cues while requiring minimal information input by an operator during use.

In accordance with a first aspect of the present invention there is provided a memory aid device comprising:

image capture means for capturing an image;

situation analysis means for generating data denoting the current status of a predetermined condition;

comparison means for comparing the generated status information with previously stored status information also relating to said predetermined condition and being associated with at least one previously captured image; and

image recall and display means,

wherein the occurrence of a positive comparison by the comparison means causes the image recall and display means to display the at least one previously captured image associated with the previously stored status information, the at least one previously captured image including visual memory cues to assist a persons memory recall.

The predetermined condition can be the location of the device and the situation analysis means may comprise position finding means. In this case the position finding means may include location data processing means, for example global positioning system receiver apparatus. Alternatively the position finding means may includes means for comparing captured images with previously captured images from known locations.

The degree of similarity between the current status and stored status of the predetermined condition required to produce a positive comparison is adjustable.

The predetermined condition can be the presence or absence of a human face in the captured image and the situation analysis means may then comprises means for analysing the captured image to detect the presence of a human face.

The predetermined condition can be the time and/or date and the situation analysis means may then comprise means coupled to a source of the time/date data and be operable to determine when the current time/date satisfies predetermined criteria for recall and display of one or more previously captured images.

In accordance with a second aspect of the present invention there is provided a method of assisting memory recall comprising the steps of:

capturing an image;

generating data denoting the current status of a predetermined condition;

comparing the generated status information with previously stored status information also relating to said predetermined condition and being associated with at least one previously captured image; and

image recall and display,

wherein the occurrence of a positive comparison during the comparison step causes the image recall and display of the at least one previously captured image associated with the previously stored status information, the at least one previously captured image including visual memory cues to assist a persons memory recall.

Other aspects and optional features of the present invention appear in the appended claims, to which reference should now be made and the disclosure of which is incorporated herein by reference, or will become apparent from reading of the following description of the preferred embodiments of the invention.

The present invention will now be described by way of example only with reference to the accompanying drawings in which:

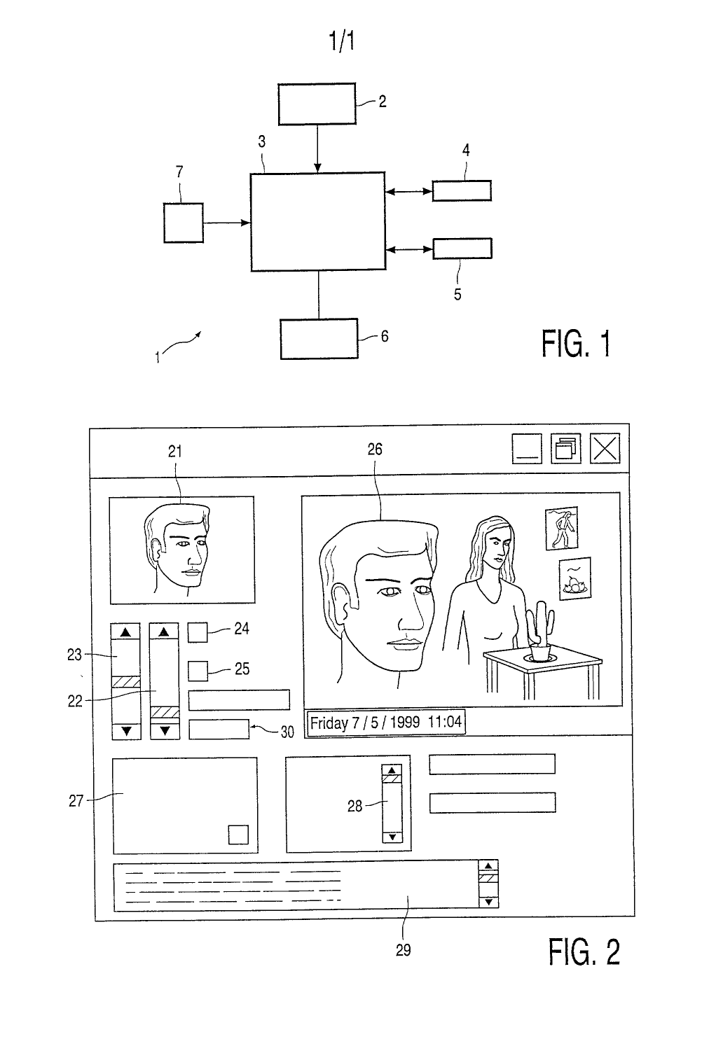

FIG. 1 is a schematic representation of apparatus embodying the present invention.

FIG. 2 is an illustration of the interface components in an example of a memory aid operating in accordance with the present invention.

Referring to FIG. 1, an example of memory aid apparatus 1 includes image capture means 2 in the form of a camera, analysis and processing means 3 for processing captured images and carrying out other processes, face data storage means 4, image data storage means 5 and display means 6. Control means 7 allows a user to operate the apparatus.

In use the camera is worn by the user at a location which allows the camera to ‘see’ what the user observes. The camera is preferably mounted somewhere in the chest area to capture the same image that the user sees when looking in a straight forward direction. The camera may be integrated into clothing or disguised as a broach, button or the like. This arrangement means that when the user meets someone and looks straight on at that person, the camera also sees an image which includes an image of that person's face.

If the image analysis means establishes that a face is present in the image, a capture of the image is taken and the processing means generates data denoting the face within the image. The composition of the captured image is such that the image includes features other than a persons face, for example the backdrop or foreground objects. The processing means then performs a comparison operation to compare the generated face data with the face data held on the face data store 4.

If no matching data is found in the store 4 then the generated face data is added to store 4. The captured image itself is saved to image data store 5 and a reference to associatively link the captured image to the stored face data is created.

If during the comparison operation matching data is found in face data store 4 the matched stored face data is retrieved from the store. The retrieved face data is associatively linked to at least one image held in the image data store 5, and the at least one linked image is also retrieved. The retrieved at least one linked image is provided to the display which is viewed by the user. Thus the user is provided with an image of that person from an earlier encounter. The display is preferably wrist worn but may take other forms such as part of a head-up display, head mounted display or face mounted display.

Through being provided with a retrieved image of a person during an earlier encounter the user is provided with memory cues. Types of memory cues include features centred about the person, for example, in the displayed image: 1) the persons hair has been bleached by the sun indicating the encounter was during summertime or the person had returned from a hot place; or 2) the person is wearing wet clothes indicating that they had been swimming . . . but was it in the sea. . . .

Other example memory cues appear in the background scene of the retrieved displayed image, for example the image background shows a famous landmark, the presence of skyscrapers, a doorway that is familiar to the user, or the inside of a bus.

All of these example memory cues help the user remember the previous encounter with the subject person. One memory cue can lead to a cascade of recollections. For example, the wet clothes indicating the seaside venue may cause the user to recollect the name of the particular beach, events that occurred on the way to the beach, events that occurred while on the beach and events that occurred on returning from the beach.

Each record in the face data store or image data store may be provided with supplementary information such as the name of the person, time and date of encounter and so forth. This information may be added by the user in the form of text or an audio clip. When this information is associated with the face data, the information is reproduced when the face data is retrieved from the store. When information is associated with an image held in the image store 5, the information is reproduced when the image is retrieved. Text data may be reproduced in the display means 6 or audibly using a text-to-speech conversion process. Audio reproduction means such as earphones may be provided.

Where a given person face is assigned one set of face data, a number of encounters with that person will result in the production of a number of captured images saved in image store 5 all being linked to that set of face data. Preferably, a match will cause the recall of the captured image relating to the most recent encounter. Other preferences may be set such that recall criteria include ‘most recent previously captured image but not those captured today’ or ‘most recent captured images but not those captured this week/in the last 12 months’ and so on.

A given persons face may be assigned with more than one set of face data, each representing a persons face but when viewed from different directions. This can improve accuracy of face recognition. In this case a ‘person record’ may be created and stored by the device and each set of face data relating to that person is linked to the ‘person record’. The association between sets of face data for a given person may be created automatically or by the user.

Details of a further embodiment system, referred to as a “visual augmented memory system” will now be given. The Visual Augmented Memory system (VAM) has two fundamental aims, to be extremely easy to use, and to provide effective retrieval cues. Ease of use is addressed by making the core functions of the VAM fully automatic. By combining face recognition with the wider visual scene, the cue contains features of the cognitive environment present when the users memory was encoded. These include who (a face, any people in the background), where (objects and landmarks in the environment), when (time stamped, light conditions, season, clothing and hair styles), and what (any visible actions, the weather). Note that in this prototype the save image data is the captured image and the generated face data is a cropped part of the captured image containing only the part filled by the face. However the recognition process can be carried out in a variety of ways based on stored images of the face or information or descriptions of the face in other ways. The VAM software is designed to run on a wearable computer facilitating a non-traditional screen, such as a head mounted display (HMD), wrist watch or remote display. FIG. 2 is an illustration of the VAM interface components including: 21 a recent view from the camera; 22 a control to set the frequency at which an image is taken (the default is 5 seconds—this reduces the CPU load on the wearable freeing it up for other applications); 23 accuracy of match required between face in captured and stored image to indicate positive face identification; 24 control to turn the VAM displays off when using an external viewer (reducing CPU load); 25 enlarge the retrieval cue image for use with HMD (default is on); and 26 the visual retrieval cue itself.

The following components are hidden by default but may be exposed by pressing the “show/hide settings” button 30: 27 Live video window; 28 the level of confidence (High/Low) needed before it is deemed that a face has been identified in a captured image (only when a face has been identified will the matching sequence be triggered); and 29 text messages describing VAM operation.

The retrieval cue in FIG. 2 appears as an image that has been too highly compressed in that it is lacking in clarity. However to the individual who experienced the event captured in the image the image acts as a memory cue causing recollection of the event and surrounding occurrences. An example of the stream of consciousness caused on presentation such an image may be ‘VANESSA. I'D PUT THE VAM ON MY DESK, IN THE LAB WITH THE OLD POSTERS.—May 1999,—PREPARING FOR AN EXHIBITION WITH VANESSA.’

The algorithm followed is as follows, mediated by the settings described above.

Upon activation all faces stored are loaded into a database.

Routine operation involves the repeated sequence

1. Every N seconds a snapshot is taken from the camera

2. If a face is detected in the snapshot:

it is saved as an image of the face together with the image of a wider field of view containing context cues, highly compressed;

the image of the face is matched against the database. A sufficient match causes the associated memory image cue to be displayed. This image is made available for external displays.

Note that memory cue acquisition and retrieval is fully automatic, with no user action required. The ideal usage requirements are—switch on and wear.

In a first prototype the original hardware system comprised of a Toshiba Libretto 100 (158×207×37 mm, 1285 g), a Videum pc-card camera (136 g), and a Samsung pc-card wireless point to point network connection to a laptop with remote display viewable by anyone walking past or loading in a web page. For wearable use a WinCE device (122×81×16 mm, 173 g) was connected to the Libretto by cable and a WinCE web browser displayed the images from a server on the Libretto.

In a second prototype new hardware has been introduced for improved wearability, including a Toshiba Libretto 1010 (152×215×28, 1000 g), Philips USB camera (50 g), and Microoptical clip on display (driver unit 99×114×45 mm, 390 g). A security dongle for the face recognition SDK was required by both systems (33×55×17 mm).

To facilitate experiments with camera and display positioning an “augmented memory jacket” was made. This had an internal system supporting the weight and bulk of the Libretto 100, cabling eyelets, and Velcro for positioning the camera and WinCE display. Detachable arms allowed for comfortable use in warm weather. Weight and cable management made wearing the VAM less conspicuous. The new hardware also fits neatly into a small shoulder bag, the camera fitting in a pocked designed for a mobile phone.

The Libretto 100 had a 838K bytes database containing 166 image pairs (face & cue) of 19 different people. Each face and cue image took typically 3.5K bytes. Recognition typically took 3 seconds from taking a picture to displaying the memory cue. The file names include a time stamp.

The software is written in Microsoft Visual Basic V5, 200 lines of code (plus UI description and comments) using the Visionics Facelt SDK V2.55. The binary is 43K bytes in size, plus Facelt and VB libraries.

Further aspects that assist in the core hands-free operation of the VAM include the managing the number of faces and cues stored. For example by linking cues of a particular person, many cues could be stored requiring only a few recent faces. Also tracking least frequently accessed cues can be the basis for forgetting.

A camera ‘zoom’ function may be included to vary the field of view such that the captured image includes that of a persons face but also at least portions showing the background or immediate surrounding area and so forth. This may be performed automatically.

A process for managing the files may also be included to re-organise and delete files in accordance with particular criteria. Such criteria include age of stored face data, age of captured image number of images associated with stored face data or person record and so forth.

There are seven optional features or modes which may be implemented, including:

1. “Exploring Memories”. A ‘time machine’ allows one to step through experiences, for example each and every time I met a certain person.

2. A “memory viewer”: Sharing your memories with others

3. “Memory Safe”: Safeguarding your memories with backup onto another device.

4. Unimportant/Very Important Button: the displayed image may be designated as unimportant or very important.

5. Privacy issue: A ‘private’ button that erases last 10, 20, 30 minutes, with each press.

6. Typing in names & notes: Names and notes about people, events and quick reminders can be entered perhaps on a desktop computer for practicality. These may be associated with individual images or individual faces.

The Visual Augmented Memory (VAM) application is a fully automated, hands free, wearable system for the identification, storage, and subsequent retrieval of visual memory cues. Faces are remembered and matched against, with pictures of the person's face and the surrounding context used as the cue. The VAM's hands free operation is a further benefit.

As will be readily understood, the recognition of faces is not the only possible means for analysing a situation to determine appropriate memory cues to generate. Other embodiments of the memory aid may include the facility of place or object recognition rather than face recognition. On returning to a place, the memory aid may recognise, for example, a particular doorway. An image including that doorway captured during a previous visit will be displayed. In place of a recognition process, previously captured images of a location may be displayed when the device determines by other means (e.g. GPS) that it has returned to that location. Positional information can be derived, for example, from global positioning system receiver apparatus. A further option has time (rather than position or the presence of a particular face) as the predetermined condition for triggering of memory cues, with the user being shown captured images from the previous day, month or year.

From reading the present disclosure other modifications will be apparent to the person skilled in the art. Such modifications may involve other features which are already known in the design, manufacture and use of systems and devices and component parts thereof and which may be used instead of or in addition to features already described herein.

1. A memory aid device comprising:
image capture means for capturing an image;
situation analysis means for generating data denoting the current status of a predetermined condition;
comparison means for comparing the generated status information with previously stored status information also relating to said predetermined condition and being associated with at least one previously captured image; and
image recall and display means,
wherein the occurrence of a positive comparison by the comparison means causes the image recall and display means to display the at least one previously captured image associated with the previously stored status information, the at least one previously captured image including visual memory cues to assist a persons memory recall.

2. The memory aid device of claim 1, wherein the predetermined condition is the location of the device and the situation analysis means comprises position finding means.

3. The memory aid device of claim 2 wherein the position finding means includes location data processing means.

4. The memory aid device of claim 3 wherein the location data processing means comprises global positioning system receiver apparatus.

5. The memory aid device of claim 2 wherein the position finding means includes means for comparing captured images with previously captured images from known locations.

6. The memory aid device of claim 2, wherein the degree of similarity between the current status and stored status of the predetermined condition required to produce a positive comparison is adjustable.

7. The memory aid device of claim 3, wherein the degree of similarity between the current status and stored status of the predetermined condition required to produce a positive comparison is adjustable.

8. The memory aid device of claim 4, wherein the degree of similarity between the current status and stored status of the predetermined condition required to produce a positive comparison is adjustable.

9. The memory aid device of claim 1, wherein the predetermined condition is the presence or absence of a human face in the captured image and the situation analysis means comprises means for analysing the captured image to detect the presence of a human face.

10. The memory aid device of claim 9 wherein the degree of similarity between the current status and stored status of the predetermined condition required to produce a positive comparison is adjustable.

11. The memory aid device of claim 1 wherein the predetermined condition is the time and/or date and the situation analysis means comprises means coupled to a source of the time/date data and operable to determine when the current time/date satisfies predetermined criteria for recall and display of one or more previously captured images.

12. A method of assisting memory recall comprising the steps of:
capturing an image;
generating data denoting the current status of a predetermined condition;
comparing the generated status information with previously stored status information also relating to said predetermined condition and being associated with at least one previously captured image; and
image recall and display,
wherein the occurrence of a positive comparison during the comparison step causes the image recall and display of the at least one previously captured image associated with the previously stored status information, the at least one previously captured image including visual memory cues to assist a persons memory recall.
